(19) United States
(12) Patent Application Publication
(10) Pub. No.: US 2025/0108254 A1
(43) Pub. Date: Apr. 3, 2025

(54) System and Method for Enhanced Tracking, and a Club for Use in the Method

(71) Applicant: TRACKMAN A/S, Hørsholm (DK)

(72) Inventors: Fredrik TUXEN, Rungsted Kyst (DK); Mads Zingenberg MACKEPRANG, Hørsholm (DK); Jesper BRASCH, Kgs Lyngby (DK)

(21) Appl. No.: 18/901,346

(22) Filed: Sep. 30, 2024

Related U.S. Application Data
(60) Provisional application No. 63/603,340, filed on Nov. 28, 2023.
(60) Provisional application No. 63/587,371, filed on Oct. 2, 2023.

(51) Int. Cl. A63B 24/00; A63B 102/32

(52) U.S. Cl. CPC A63B 24/0003; A63B 2102/32; A63B 2220/05; A63B 2220/806

(57) ABSTRACT

Apparatus and methods are described for enhancing the tracking of sports related items using markers facilitating the identification by a tracking device of specific positions associated with these items so that the positions of the items during a striking process can be more accurately determined. For example, a system includes a tracking device tracking motion of a golf club and generating tracking data corresponding to a position of the club during a swing and a processor analyzing the data to identify a portion corresponding to a marker positioned on the club. The marker reflects a target type of radiation in a manner distinguishable from the reflection of radiation from portions of the club excluding the marker. The processor determines, based on the tracking data corresponding to the portions of the club excluding the marker and the tracking data corresponding to the marker, a three-dimensional trajectory of the club.

### PRIORITY CLAIM

The application claims priority to U.S. Provisional Patent Application Ser. No. 63/587,371 filed Oct. 2, 2023 and U.S. Provisional Patent Application Ser. No. 63/603,340 filed Nov. 28, 2023. The specifications of these applications are incorporated herewith by reference.

### BACKGROUND

Systems have been developed for the tracking of sports balls and for analyzing player motions (e.g., swings, throwing and kicking motions, etc.) to, for example, enhance sports broadcasts and to facilitate athlete training, etc. These systems have included various tracking devices such as, for example, radars, imagers, and other sensors, to track and analyze the motion of balls, athletes, and/or related items (e.g., rackets, bats, clubs, etc.).

### SUMMARY

The present disclosure relates to a system for tracking a motion of a golf club. The system includes a tracking device configured to track motion of a golf club and generate tracking data corresponding to a position of the golf club during a swing of the golf club; and a processor analyzing the tracking data to identify a portion of the tracking data corresponding to a first marker positioned on the golf club, the first marker being configured to reflect a target type of radiation in a manner distinguishable from the reflection of radiation from portions of the golf club excluding the first marker, the processor being configured to determine, based on the tracking data corresponding to the portions of the golf club excluding the first marker and the tracking data corresponding to the first marker, a three-dimensional trajectory of the golf club.

According to an embodiment, the tracking data includes data corresponding to at least one of Face Angle, Dynamic Loft, club speed, attack angle, and club path.

According to an embodiment, the tracking device includes a first camera and the tracking data comprises a series of images generated by the first camera during the swing of the golf club, the processor being configured to identify the first marker in the images and to analyze positions of the first marker in the images to determine a three-dimensional position and orientation of the golf club at times corresponding to each of the images of the series of images.

According to an embodiment, the tracking device includes a radar unit and wherein the tracking data comprises radar data corresponding to one of a range and a range rate of a target portion of the golf club relative to the radar unit.

According to an embodiment, the target portion of the golf club includes a head of the golf club and wherein the first marker is located on the head of the golf club.

According to an embodiment, the tracking device includes a radar unit and wherein the radar unit transmits radiation in a radar frequency range and wherein the first marker is a radar reflector element having a reflectivity with respect to radiation within the radar frequency range that differs from a reflectivity with respect to radiation within the radar frequency range of a portion of the golf club surrounding the first marker, the processor being configured to identify within the tracking data a portion of the tracking data corresponding to movement of the first marker.

According to an embodiment, when the golf club includes a second marker positioned on a head of the golf club, the processor is configured to determine based on a portion of the tracking data corresponding to movement of the first and second markers, a three-dimensional path of movement of the head of the golf club during the swing.

According to an embodiment, the processor is configured to determine, based on the portion of the tracking data corresponding to the movement of the first and second markers, a three-dimensional orientation of the head of the golf club during the swing.

According to an embodiment, the first camera faces a target area within which the golf club is to be swung, the first camera being positioned to capture images of a face of a head of the golf club when the golf club is swung in the target area in a target direction.

According to an embodiment, the system further comprising a second camera facing the target area, the second camera being positioned to capture images of a rear surface of the head of the golf club when the golf club is swung in the target area in the target direction.

According to an embodiment, the tracking device includes a radar unit transmitting radiation in a radar frequency range and wherein the first marker is a radar reflector element, the radar reflector element having a reflectivity with respect to radiation in the radar frequency range by the radar unit that differs from a reflectivity with respect to radiation within the radar frequency range of a portion of the golf club surrounding the first marker, the processor being configured to identify within the tracking data a portion of the tracking data corresponding to movement of the first marker, the radar unit being positioned behind the target area facing the rear surface of the head of the golf club when the golf club is swung in the target area in the target direction.

According to an embodiment, the tracking device includes a radar unit and wherein the radar unit transmits radiation within a radar frequency range and wherein the first marker is a radar reflector element, the radar reflector element having a reflectivity with respect to radiation within the radar frequency range that differs from a reflectivity with respect to radiation within the radar frequency range of a portion of the golf club surrounding the first marker, the processor being configured to identify within the tracking data a portion of the tracking data corresponding to movement of the first marker, the radar unit being positioned above the target area.

According to an embodiment, the tracking device includes a radar unit and wherein the radar unit transmits radiation within a radar frequency range and wherein the first marker is a radar reflector element having a reflectivity with respect to radiation within the radar frequency range that differs from a reflectivity with respect to radiation within the radar frequency range of a portion of the golf club surrounding the first marker, the processor being configured to identify within the tracking data a portion of the tracking data corresponding to movement of the first marker, the radar unit being positioned in front of the target area facing the face of the head of the golf club when the golf club is swung in the target area in the target direction.

According to an embodiment, the tracking device includes a radar unit and wherein the radar unit transmits radiation within a radar frequency range and wherein the first marker is a radar reflector element having a reflectivity with respect to radiation within the radar frequency range that differs from a reflectivity with respect to radiation within the radar frequency range of a portion of the golf club surrounding the first marker, the processor being configured to identify within the tracking data a portion of the tracking data corresponding to movement of the first marker.

According to an embodiment, the first camera is positioned above a target area within which the golf club is to be swung, the first camera being positioned above to capture images of a top of a head of the golf club when the golf club is swung in the target area in a target direction.

According to an embodiment, the radar unit is a three-dimensional doppler radar and wherein the tracking data includes three-dimensional positioning data for a head of the golf club during at least a portion of a golf swing before and through a time of impact with a golf ball.

According to an embodiment, the tracking data includes an orientation of the head of the golf club during the portion of the golf swing.

According to an embodiment, the first camera is sensitive to light in a near infra-red portion of a spectrum and wherein, when the first marker is distinguishable from a material of the golf club surrounding the first marker in the near infra-red spectrum and is not distinguishable from the material of the golf club surrounding the first marker in a visible portion of the spectrum.

In addition, the present disclosure relates to a method for tracking a motion of a golf club comprising: generating tracking data via a tracking device configured to track motion of a golf club, the tracking data corresponding to a position of the golf club during a swing of the golf club; and analyzing, using a processor, the tracking data to identify a portion of the tracking data corresponding to a first marker positioned on the golf club, the first marker being configured to reflect a target type of radiation in a manner distinguishable from the reflection of radiation from portions of the golf club excluding the first marker, the processor being configured to determine, based on the tracking data corresponding to the portions of the golf club excluding the first marker and the tracking data corresponding to the first marker, a three-dimensional trajectory of the golf club.

According to an embodiment, the tracking data includes data corresponding to at least one of Face Angle, Dynamic Loft, club speed, attack angle, and club path.

According to an embodiment, the tracking device includes a first camera and the method further comprising: generating, via the first camera, a series of images during the swing of the golf club, and identifying via the processor the first marker in the images and analyzing, using the processor, positions of the first marker in the images to determine a three-dimensional position and orientation of the golf club at times corresponding to each of the images of the series of images.

According to an embodiment, the tracking device includes a radar unit and the method further comprising: generating, via the radar unit, radar data corresponding to one of a range and a range rate of a target portion of the golf club relative to the radar unit.

According to an embodiment, the tracking device includes a radar unit generating radiation in a radar frequency range and wherein the first marker is a radar reflector element having a reflectivity with respect to radiation within the radar frequency range that differs from a reflectivity with respect to radiation within the radar frequency range of a portion of the golf club surrounding the first marker, further comprising identifying within the tracking data via the processor a portion of the tracking data corresponding to movement of the first marker.

According to an embodiment, when the golf club includes a second marker positioned on a head of the golf club, determining by the processor based on a portion of the tracking data corresponding to movement of the first and second markers, a three-dimensional path of movement of the head of the golf club during the swing.

According to an embodiment, the method further comprises determining by the processor, based on the portion of the tracking data corresponding to the movement of the first and second markers, a three-dimensional orientation of the head of the golf club during the swing.

According to an embodiment, the method further comprises capturing, using the first camera, images of a face of a head of the golf club during the swing of the golf club.

According to an embodiment, the method further comprises capturing via a second camera images of a rear surface of the head of the golf club during the swing of the golf club.

According to an embodiment, the tracking device includes a radar unit generating radiation in a radar frequency range and wherein the first marker is a radar reflector element having a reflectivity with respect to radiation within the radar frequency range that differs from a reflectivity with respect to radiation within the radar frequency range of a portion of the golf club surrounding the first marker, further comprising identifying within the tracking data by the processor a portion of the tracking data corresponding to movement of the first marker, the radar unit being positioned behind a target area facing the rear surface of the head of the golf club when the golf club is swung in the target area in a target direction.

According to an embodiment, the tracking device includes a radar unit generating radiation in a radar frequency range and wherein the first marker is a radar reflector element having a reflectivity with respect to radiation within the radar frequency range transmitted by the radar unit that is differs from a reflectivity with respect to the radar frequency range transmitted by the radar unit of a portion of the golf club surrounding the first marker, the processor being configured to identify within the tracking data a portion of the tracking data corresponding to movement of the first marker, the radar unit being positioned above the target area.

According to an embodiment, the tracking device includes a radar unit generating radiation in a radar frequency range and wherein the first marker is a radar reflector element having a reflectivity with respect to radiation within the radar frequency range that differs from a reflectivity with respect to radiation within the radar frequency range of a portion of the golf club surrounding the first marker, further comprising identifying within the tracking data by the processor a portion of the tracking data corresponding to movement of the first marker, the radar unit being positioned in front of a target area facing the face of the head of the golf club when the golf club is swung in the target area in a target direction.

According to an embodiment, the tracking device includes a radar unit generating radiation in a radar frequency range and wherein the first marker is a radar reflector element having a reflectivity with respect to radiation within the radar frequency range that differs from a reflectivity with respect to radiation within the radar frequency range of a portion of the golf club surrounding the first marker, further comprising identifying within the tracking data by the processor a portion of the tracking data corresponding to movement of the first marker.

According to an embodiment, the method further comprises capturing, using the first camera, images of a top of a head of the golf club during the swing of the golf club.

According to an embodiment, the radar unit is a three-dimensional doppler radar and wherein the tracking data includes three-dimensional positioning data for the head of the golf club during at least a portion of the swing before and through a time of impact with a golf ball.

According to an embodiment, the tracking data includes an orientation of the head of the golf club during the portion of the swing.

In addition, the present disclosure relates to a golf club comprising: a shaft; and a clubhead coupled to the shaft, the clubhead comprising a face and a body, wherein the body includes a radar reflector element mounted therein, the radar reflector element being formed of a material having a first reflectivity with respect to a target wavelength of radiation different from a reflectivity of the rest of the clubhead to facilitate radar tracking of a location of the radar reflector element.

According to an embodiment, the radar reflector element is formed on a back surface of the clubhead.

According to an embodiment, the radar reflector element is configured to generate a hotspot in a doppler radar signal corresponding to motion of the clubhead, the hotspot including data corresponding to one of a range and a range rate of the location of the radar reflector element.

According to an embodiment, the radar reflector element is located in a predetermined position relative to the face of the clubhead.

According to an embodiment, the radar reflector element comprises a retroreflector.

According to an embodiment, the retroreflector is a corner reflector having first and second metal surfaces substantially perpendicular to one another.

According to an embodiment, the first and second metal surfaces of the corner reflector include at least one of silver, copper, gold, and aluminum.

According to an embodiment, the radar reflector element has a largest dimension smaller than a wavelength of a radar signal from the radar.

According to an embodiment, the radar reflector element has a largest dimension between one fourth and 3/2 of a wavelength of a radar signal from the radar.

According to an embodiment, the radar reflector element includes a frequency selective spherical lens reflector.

According to an embodiment, the frequency selective spherical lens reflector includes a silica ball lens with a reflective hemispherical cap opposite a frequency selective surface.

According to an embodiment, the golf club further comprising: an aperture covered by the frequency selective surface.

According to an embodiment, the frequency selective surface forms a repetitive pattern forming a crossed-dipole aperture.

According to an embodiment, the repetitive pattern includes an electroplated Nickel layer covering the aperture.

According to an embodiment, the radar reflector element is embedded into the body of the clubhead.

### BRIEF DESCRIPTION OF DRAWINGS

FIG. 1 shows an exemplary system according to the present disclosure for measuring various aspects of a golf ball and a golf club during a swing.

FIG. 2 shows an exemplary system to measure various aspects of a golf ball and a golf club during a swing and for processing and presenting determined data.

FIG. 3 shows an exemplary clubhead seen from face side.

FIG. 4 shows a side view of the clubhead shown in FIG. 3.

FIG. 5 shows a rear view of the clubhead shown in FIG. 2.

FIG. 6 shows schematically a corner reflector for use in a clubhead according to the present disclosure.

FIGS. 7a-7f show alternative marker shapes including orientation information.

FIG. 8 shows an alternative embodiment of the radar reflector element for use in a clubhead according to the present disclosure.

FIG. 9 shows repetitive pattern for use in the radar reflector element shown in FIG. 8.

FIG. 10 shows a clubhead according to a further embodiment according to the present disclosure including markers.

FIG. 11 shows a back of a clubhead according to a yet another embodiment according to the present disclosure with markers.

FIG. 12 shows a further embodiment according to the present disclosure of a clubhead with markers.

FIG. 13 shows a tracking according to a further embodiment.

FIG. 14 shows a perspective view of a scene observed by the tracking device of FIG. 13.

### DETAILED DESCRIPTION

The exemplary embodiments of the present disclosure may be further understood with reference to the following description and the related appended drawings, wherein like elements are provided with the same reference numerals. The exemplary embodiments relate to systems and methods for analyzing the swinging motion of devices for striking sports balls, pucks, etc. including, for example, golf clubs, baseball and cricket bats, hockey sticks, etc. Although the examples given in the specification will describe the use of the inventive apparatus in conjunction with golf clubs and the analysis of a golf swing, those skilled in the art will understand that the same or similar techniques may be implemented to analyze the swing of other devices for striking sports balls.

In recent years, various apparatuses have been developed to analyze sporting techniques and performance to, for example, provide information to be used in training as well as to provide to an audience information enhancing the understanding and enjoyment of sports broadcasts. The apparatus employed to track and analyze sports performance generally includes devices for tracking the motion of balls, pucks, etc. as well as the motion of devices for striking these items including, not only items such as balls and bats but also, parts of player anatomy used in striking balls (e.g., players' hands and feet). For example, optical and/or radar reflective markers of the same type described in this application for use in the heads of golf clubs may be placed on shoes for soccer (football) or American football) to enhance the tracking of the kicking motion which is useful for training purposes.

In addition, these markers may be used in the same manner in gloves such as golf gloves, hockey gloves and/or baseball batting gloves to enhance the tracking of the hands in the swinging of golf clubs, hockey sticks and baseball bats, etc. As will be described below, this tracking which has generally been performed using radar and/or cameras to generate data enabling the tracking of the position and orientation of these items during the striking process can be made more reliable and accurate through the use of markers that enable more precise tracking of different parts of the tracked item (e.g., enabling accurate tracking of the 3D motion of any of these items by enhancing the tracking the positions of different points on the tracked item during its motion before, during and after impact with a ball, puck, etc.).

The present disclosure describes enhancements to these items to enhance the tracking device's ability to accurately determine the 3D path of motion and orientation of the item to enable the devices to provide more accurate data on the impact between the items and the balls. The enhancements include markings/reflectors configured to enhance the optical and radar tracking by so-called launch monitors used in the golf industry, such as Trackman 4, Trackman iO, Foresight GC Quad, Foresight Hawk, FlightScope X3, Uneekor EYE XO(2) etc. The current launch monitors use either Doppler radar, camera sensors or a combination of both. Optical markings described herein may include retroreflective markers configured, for example, for sensitivity to a wavelength range used by imaging components of current launch monitor system. This might be in the visual spectrum or infrared spectrum such, e.g., as 810-850 nm. The radar reflectors may then be optimized, for example, for wavelengths used by current launch monitor systems—typically X band (10.5-10.6 GHz) and/or K band (24.0-24.25 GHz).

Those skilled in the art will understand that the optical and markings and radar reflector elements may be placed on the clubhead in a manner configured to provide a clear signal within at least the last 0.2-0.5 m before the clubhead impacts the ball through the time of impact. Currently, launch monitors are often placed behind a tee position looking in a down-the-line angle. In this case markers/reflectors are typically placed on the rear of the club head. Other launch monitors are configured for placement above or to the side and in front of the tee position. In this case, the markers/reflectors are preferably placed on the club face, maybe on the perimeter of the club face. Obviously clubheads with markings/reflectors at both general locations can be designed to accommodate for more multiple launch monitor systems.

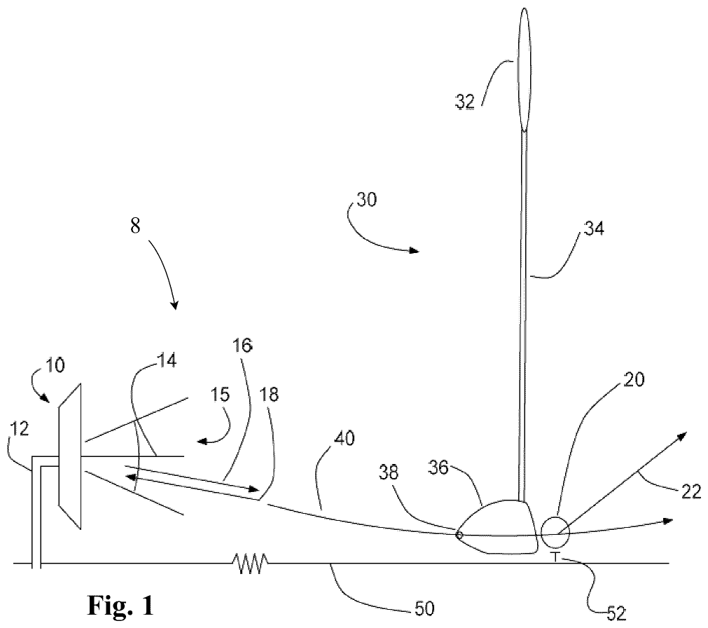

A system 8 as shown in FIG. 1 includes a golf launch monitor which, in this embodiment, includes a radar unit 10 using, for example, doppler radar technology to measure the motion of a ball (e.g., a golf ball 20) and to track the motion of a golf club 30 during a swing. In the illustrated embodiment, the radar unit 10 is arranged behind the golf ball 20 when a user is preparing to swing the golf club 30 to launch the ball directly away from the radar unit 10. That is, in this example, the radar unit 10 is aimed in generally the same direction as the user is aiming his shot. The golf club 30 shown in this example is a driver which is often used to take a golfer's first shot on a hole. As those skilled in the art understand, this first shot is generally taken from an area called the tee box where the golf ball 20 can be propped above the ground 50 on a tee 52.

As shown, the standard golf club 30 includes a clubhead 36 coupled to a shaft 34 which ends at a grip or handle 32 configured to be grasped by a golfer. When a golfer swings the golf club 30, the clubhead 36 moves along a curved (substantially circular) path illustrated by an arc segment 40 towards impact with the golf ball 20. After impact with the clubhead 36, the golf ball 20 leaves the tee box in a direction marked with an arrow 22. In any case, as would be understood by those skilled in the art, in addition to drivers, various golf clubs 30 with different clubheads 36 (e.g., fairway woods, irons, hybrid clubs, pitching and sand wedges, etc.) may employ markers in the same manner as described for the exemplary clubhead 36 without departing from the teaching of these embodiments.

As indicated above, the clubhead 36 of the golf club 30 according to this embodiment has a face configured to impact the ball and a body configured to optimize the transfer of energy from the clubhead 36 to the golf ball 20 in a desired manner to enable the golfer to consistently achieve a target trajectory of the golf ball 20. However, slight changes to the path of movement of the clubhead 36 and/or to the orientation of the face of the clubhead 36 as well as changes in the portion of a path of motion of the clubhead 36 at which the clubhead impacts the golf ball 20 can have a large impact on the resulting trajectory of the golf ball 20. Thus, accurate tracking of the path of motion of the clubhead 36 and the orientation of the clubhead 36 as well as the motion of the rest of the golf club 30 that generates this motion of the clubhead 36 is important in analyzing and improving the swings of golfers.

The radar reflector elements 38 and/or the markers 110 included in the clubhead 36 according to this embodiment are configured to enhance a determination of club delivery parameters by a tracking system 8 or 9 by improving the accuracy of radar and/or optical tracking. As those skilled in the art will understand, the radar reflector elements 38 and/or markers 110 may be modified (e.g., in their responsiveness to different types of radiation) to render them more effective in combination with any other desired tracking mode (e.g., microwave 120-122 Ghz, visual spectrum 500-700 NM and IR 800-900 NM). For example, in one embodiment, the markers 110 may be formed on an outer surface of the clubhead 36 so that they may be recorded in images using natural light while the radar reflector elements 38 will generally have a reflectivity with respect to the wavelength of the transmitted radiation 16 to be transmitted by the radar unit 10 that differs significantly from the reflectivity of the materials in the clubhead 36 surrounding the radar reflector element 38.

In one example, the reflectivity of the material of the radar reflector element(s) 38 is stronger than the reflectivity of any of the materials forming the rest of the clubhead 36. The radar reflector element 38 preferably is formed of an electrically conductive material and has a thickness of 20μ or more and a height and width of 4 mm. Those skilled in the art will understand that the reflectivity of the radar reflector elements 38 as well as the structure of the radar reflector elements 38 is selected so that the radar reflector element 38 generates an identifiable hotspot in the radar data throughout the motion of the element being tracked as the position and angulation of the radar reflector elements 38 changes relative to the radar (e.g., as the clubhead 36 moves and rotates relative to the radar). As would be understood, for items made of components having different levels of reflectivity to the radiation from the radar, the amount of energy reflected by the radar varies depending on the angulation of the item being tracked relative to the radar. The radar reflector elements 38 are preferably constructed to reflect energy sufficiently through a wide angular range so that a hotspot corresponding to each of the radar reflector elements 38 is consistently generated throughout at least a target portion of the motion of the item to be tracked (e.g., the clubhead 36). This can be enhanced also by taking into the account the positioning of the radar relative to the item to be tracked such as, for example, placing a radar behind a golfer so that the radar reflector elements 38 on the rear of a clubhead 36 will be facing the radar throughout at least a portion of the motion of the clubhead 36 immediately prior to and through the time of impact with the golf ball 20.

As those skilled in the art would understand, it is important that the markers 110 designed for use with visible light reflect light in the visual frequency range in a manner that will make the markers 110 stand out in comparison to surrounding portions of the clubhead 36.

In another embodiment, markers 110 may be embedded below the surface of the clubhead 36 for reflection by markers reflective to infrared light after this light has passed through an outer portion of the clubhead 36 that is transparent or partially transparent to infrared light. As would be understood by those skilled in the art, in this case, the markers 110 should be comprised of material having a high reflectivity for infrared radiation. In this embodiment, as the body of the clubhead 36 includes a radar reflector element 38 in a position relative to the face of the clubhead 36 known to the tracking system so that the tracking system can identify a portion of the reflected radiation 18 that corresponds to this location and use this radar data along with knowledge of the position of the marker on or in the clubhead 36 to enhance the accuracy of the tracking of the movement and orientation of the clubhead 36.

As indicated above, the radar unit 10 may include, for example, an FMCW 3D Tracking Radar configured to deliver a determination of club delivery parameters from the impact between the golf club 30 and the golf ball 20 or may alternatively include a simple CW radar sensor or a MFCW (Multi-frequency CW) sensor, the operation of which will be understood by those skilled in the art. The type of radar used for the radar unit 10 is unimportant to the present embodiments except to the extent that the radar reflector element 38 must be configured to reflect the energy produced by the radar unit 10 in a manner that is significantly different from the materials of the rest of the clubhead 36 so that the portion of the reflected radiation 18 that is reflected from the radar reflector element 38 stands out from the rest of the reflected radiation 18 (generated by reflection from the rest of the clubhead 36).

As will be indicated below, this difference in reflectivity between the radar reflector element 38 and the rest of the clubhead 36 enables the tracking system to more accurately analyze the portion of the signal relating to the radar reflector element 38 itself and to precisely locate the radar reflector element 38 in space. This in turn, enables the system 8 or 9, using a priori information concerning the location of the radar reflector element 38 on the clubhead 36, to determine the precise three-dimensional location and orientation of the clubhead 36 during the swinging motion and before, during and after impact with the golf ball 20. This a priori knowledge may include information regarding the size, shape and/or location of the optical markings enabling the system to analyze position and three-dimensional orientation of the club face based on the position, shape, and distance of separation between the various markings in each of the images.

The system 8 includes a radar unit 10 arranged behind the golf ball 20 at a distance selected so the golfer does not risk hitting the radar unit 10 when swinging the golf club 30. The radar unit 10 may be mounted on a stand 12 resting on the ground 50, as would be understood by those skilled in the art, may be arranged in any manner suitable to provide a radar signal to the clubhead 36 and to receive a reflection of the signal from the clubhead 36 including a portion of the signal reflected from the radar reflector element 38. For example, the radar unit 10 may be mounted permanently behind the tee box or may be mobile.

The radar unit 10 of FIG. 1 has a main axis 14 and a field of view 15 and in one example radiates a continuous transmission power such as a simple continuous wave radar. When a reflected radiation 18 (marked with an arrow) is received by the radar unit 10, differences in phase or frequency between the transmitted radiation 16 and the reflected radiation 18 are measured to determine, for example, a range or range rate, relative to the radar unit 10, of the object from which the reflected radiation 18 was reflected. For example, an FMCW 3D Tracking Radar sensor may simultaneously measure a range and velocity (relative to the radar unit 10) of a moving object with a very high accuracy.

For a driver, the difference between the path of the center of gravity (CoG) 105 of the clubhead 36 and the path of the center of the club face 100 is approximately three degrees (center of club face path being more outside-in). This is because the CoG 105 is located approximately 25-50 mm behind the club face 100. The same counts for Attack Angle of the CoG 105 and the center of the club face 100, where the center of the club face 100 moves more upward compared to the CoG 105 for a driver (e.g., typically one degree).

Golfers have an interest in receiving data concerning Club Speed, Attack Angle and Club Path relative to the CoG 105, or more precisely relative to the geometric center of the clubhead 36. The motivation for selecting the CoG 105 as a reference point is that the mass of the clubhead 36 is what the golfer is swinging and what collides with the golf ball 20 and makes it move. As would be understood by those skilled in the art, other reference points can be selected for club speed, attack angle, and club path, such as the center of the club face or any other suitable point.

As seen in FIG. 3, the club face 100 side of the clubhead 36 in this embodiment includes a plurality of markers 110 distributed in a pattern known to and recognizable by the processor 62 when analyzing image data captured by the camera 72. The processor 62 preferably includes, in advance, information concerning the pattern. This information may be gained through use of a global standard for the relative positions of individual markers 110 in the pattern or by entering data concerning a club ID, by registering a club with the system before use, etc. In an alternative embodiment, the club manufacturer may provide data concerning a club specific pattern for the markers 110, and the processor 62 may request patterns data from a server 75 (e.g., a cloud-based server or any other remote computing device) based on club type or a specific club ID for the individual golf club 30.

Alternatively, if the processor 62 does not include a priori information on the locations and/or the pattern of distribution of the markers 110 on the clubhead 36, the processor 62 can still use the locations of the markers 110 in the images from the cameras 70, 72 to enhance the tracking of the position and orientation of the clubhead 36 throughout the swing as the positions of the markers 110 on the clubhead will remain consistent throughout the swing. That is, the processor 62 can use the markers 110 as fixed points of reference on the clubhead 36 so that, for example, relative movement of these markers 110 in the images can be used to determine changes in orientation of the clubhead relative to the cameras 70, 72 in a known manner. That is, because the markers 110 are connected to one another by the rigid structure of the clubhead 36, the processor 62 can assume that there is no relative movement between the markers 110 and, therefore, any movement of these markers relative to one another in the images represents a change in the orientation of the clubhead 36 relative to the planes of the images from the cameras 70, 72.

The markers 110 on the rear side of the clubhead 36 are also distributed in a pattern recognizable by the processor 62 when analyzing image data captured by the camera 70. The processor 62 also preferably includes, in advance, information regarding the pattern of these markers 110. By calibrating the radar unit 10 and at least one of the cameras 70 or 72, the processor 62 is able to track the path of the radar reflector element 38, and to track twisting and rotation of the clubhead 36 during the downswing, through impact with the golf ball 20 and through part of a follow-through portion of the swing after impact with the golf ball 20. Those skilled in the art will understand that multiple radar reflector elements 38 may also be distributed over the back-facing and front-facing sides of the clubhead 36 in the same manner described in regard to the markers 110 and that this will enable the processor 62 to more accurately determine the three-dimensional position and orientation of the clubhead 36 throughout the swing and particularly at impact.

As described in regard to the markers 110, the processor 62 can also use radar data associated with one or more radar reflector elements 38 even if the location of one or more of the radar reflector elements 38 is not known to the processor 62. That is, as the radar reflector elements 38 show a position relative to other parts of the clubhead 36 that remains consistent throughout the swing motion, the processor 62 can use the data regarding the changes in position of the reflector element over time to correlate to the changes in position of other parts of the clubhead 36 over the same time period. Similarly, when multiple radar reflector elements 38 are present in the clubhead 36, the processor 62 can monitor relative movement between these rigidly connected items to determine changes in orientation of the clubhead 36 relative to the radar unit 10 as described above in regard to the markers 110.

The markers 110 and/or the radar reflector element 38 facilitate a significant improvement in the club data obtained (e.g., Face Angle, Dynamic Loft, club speed, attack angle, and club path). The markers 110 and/or the radar reflector element 38 permit the detection of the often significant differences between a club face orientation of the center of the club face and the orientations of other locations on the club face 100 that can occur due, for example, to roll and bulge of the club face 100. For a driver, e.g., impact 10 mm away from a center of the club face toward the toe may cause the Face Angle to be two degrees more open at the impact location than it is when impact occurs at the center of the club face. Similarly, impact on the club face 10 mm lower than a center of the club face may cause the Dynamic Loft to be two degrees lower at the impact location than it would have been if impact had occurred at the center of the club face 100.

Club Speed, Attack Angle, and Club Path data reflects to a large extent how the player swings the golf club 30. A golf club 30 including markers 110 and/or a radar reflector element 38 according to the disclosed embodiments enhances the determination of the orientation and direction of the club face 100 at the impact location in the brief time span during which the clubhead 36 and the golf ball 20 contact one another. This closely aligns with the orientation of the club face 100 at maximum compression so that the precise location and orientation of the club face 100 at the moment of impact may be used to define Face Angle and Dynamic Loft in a manner that most accurately explains the three-dimensional trajectory of the golf ball 20.

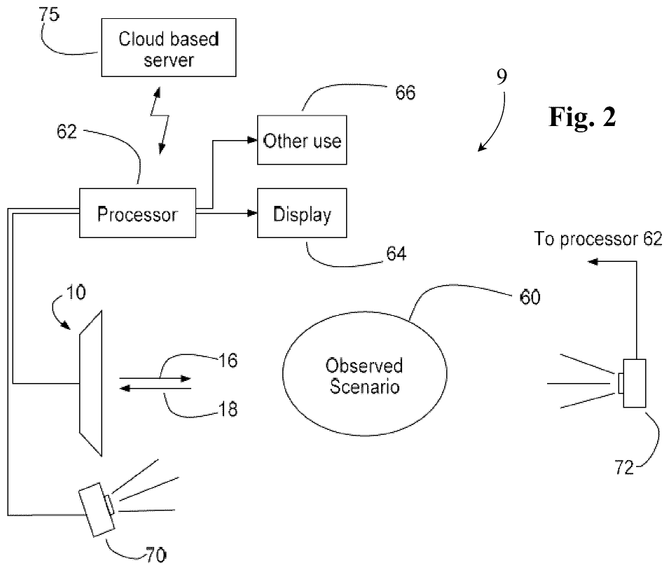

As shown in FIG. 2, a system 9 for tracking the movement of a golf club 30 and a golf ball 20 according to a further embodiment, includes a radar unit 10 in combination with an imaging apparatus (e.g., the camera 70) to capture the ball and club data. In other embodiments, the radar unit 10 includes two separate radar arrays each independently tracking one of the golf balls 20 and the clubhead 36 or cooperating in the tracking of both the clubhead 36 and the golf ball 20. This allows for more precise and reliable measurements, especially for the data regarding the motion and orientation of the clubhead 36.

For example, K-band radars will operate around 24 GHz, and X-band radars operate around 10 GHz. This will give wavelengths for the two radar bands at 1.25 cm and 3.0 cm, respectively. The precision of an FMCW radar range measurement depends on several factors, such as the bandwidth of the transmitted signal, the signal-to-noise ratio, the sampling rate, and the signal processing techniques. Optimizing the radar unit 10 and the later applied signal processing techniques, it is possible obtain a precision below one wavelength.

The radar unit 10 of a tracking system 9 shown in FIG. 2 transmits a signal (e.g., a transmitted radiation 16) towards a scenario 60 to be observed (e.g., a golf swing and resulting impact with a golf ball) and receives a reflected signal (e.g., a reflected radiation 18) after reflection from one or more objects in the scenario 60. As would be understood by those skilled in the art, doppler radar signal processing uses the Doppler effect to measure the velocity and distance to moving targets (from the radar unit 10) by analyzing a frequency shift of the reflected radiation 18 as compared to the radar signal transmitted by the radar unit 10. A processor 62, which may be integrated into a housing of the radar unit 10 or in a separate device processes the reflected radiation 18 to extract features such as target range, speed, direction, and shape, of the moving elements in the scenario 60, e.g., the golf club 30 and the golf ball 20 in a manner understood by those skilled in the art.

By monitoring the scenario 60 up to and after impact, it is possible to calculate trajectories for both the golf club 30 and the golf ball 20. The system 9 may include an arrangement for generating images of the scenario 60. The arrangement may include at least one sensor, a high-speed infrared imager, a camera 70 (e.g., a high-speed camera), etc. As would be understood by those skilled in the art, the camera 70 may be integrated in the housing of the radar unit 10 or included as a separate device and has a field of view covering the scenario 60 and thereby at least partly overlaps the field of view of the radar unit 10. If the camera 70 is a separate device from the radar unit 10, the processor 62 will require information concerning the geometric relationship between the location and orientation of the camera 70 and the radar unit 10 so that information from the camera 70 and the radar unit 10 can be translated into a common frame of reference. The information from various components of the system 9 will also be time synced so that images and radar data representing the same moments in time can be used to more accurately determine the position and orientation in three-dimensional space of the golf club 30, the clubhead 36 and the golf ball 20 at all relevant times.

The system 9 also includes an optional second arrangement facing the scenario 60 from a direction different than the point of view of the camera 70. The second arrangement may include at least one sensor, a high-speed infrared imager, a camera 72 (e.g., a high-speed camera), etc. The field of view of the camera 72 also covers the scenario 60 and at least partially overlaps with the fields of view of the radar unit 10 and the camera 70 so that the striking of the golf ball 20 may be monitored various directions by the cameras 70 and 72 as well as by the radar unit 10.

The processor 62 applies feature extraction to extract useful information from image signals received from the camera 70 (and the camera 72, if present), such as shape, size, orientation and/or motion pattern, by using appropriate techniques, such as structure function, empirical mode decomposition, principal component analysis, or artificial intelligence as would be understood by those skilled in the art. Those skilled in the art will understand that the processor 62 may also have access to a database including geometric and other properties of a wide variety of golf clubs 30, shafts 34 and clubheads 36 so that this club related data may be used to further refine calculations regarding the position and orientation of the clubhead 36 throughout the swing and impact with the golf ball 20. That is, the system 9 may identify the clubhead 36 and/or a type of the shaft 34 in any of a number of ways (e.g., after input of such data by a user, through identification of these components via image analysis (e.g., via analysis of markings on the golf club 30 or clubhead 36, or via an analysis of the shape and size of components) or through the decoding of patterns of markings on the golf club 30 and/or clubhead 36 as will be described below).

The processor 62 may then combine radar data from the radar unit 10 with image data from the camera(s) 70, 72 to track the movement of the clubhead 36 and the golf ball 20. Thus, for example, the system 9 may collect images and radar data continuously when the system 9 is switched on, automatically beginning from the time a swinging motion is detected, or from a time at which the clubhead 36 enters the field of view for the radar unit 10 and the cameras, 70 and 72 until the time the golf ball 20 leaves the field of view for the radar unit 10 and the cameras, 70 and 72 (or for any other relevant time period), to determine through image analysis alone or through the analysis of radar data alone or of image data in combination with radar data (or any other tracking data) data for the golfer such as ball speed, launch angle, spin rate, spin axis, carry distance, total distance, and many other parameters in addition to data relevant to the analysis of the golfer's swing. This swing related data may comprise, for example, speed of the clubhead 36, a face angle of the golf club 30, a dynamic loft of the golf club 30, an attack angle of the golf club 30 and a path of the golf club 30 and the clubhead 36 throughout the swinging motion from the backswing through impact with the golf ball 20 and during a follow-through period after impact.

From FIG. 2 it may also be seen that the processor 62 includes an optional connection to the server 75 via any known connection. The processor 62 may upload data to the server 75 regarding the golfer, the equipment used by the golfer, or the performance of the golfer to an account of the golfer, an account of the equipment manufacturer or an account of the data owner for the radar unit 10 or to any other relevant entity. The processor 62 may download data from the server 75 regarding the golfer, or the equipment used by the golfer from an account of the golfer, an account of the equipment manufacturer or an account of the data owner for the radar unit 10 or from any other suitable source. The processor 62 delivers output including, for example, club data and ball data including a trajectory for presentation, e.g., on a display 64 or to be used in other devices 66, such as simulators or virtual reality equipment or in systems for fitting golf clubs, etc.

FIGS. 3, 4 and 5 illustrate a clubhead 36 in more detail. The clubhead 36 in this example is for a driver including a club face 100, a sole 104, a crown 106, and a hosel 108 at which the clubhead 36 is connected to the shaft 34. As would be understood by those skilled in the art, each of these parts can have different shapes, sizes, materials, and designs that affect the performance and feel of the driver. In fact, golfers often select clubs based on an assessment of the golfer's individual swing characteristics in based on a fitting in which the golfer's swing is analyzed. This can involve the golfer striking multiple balls using different clubheads 36 attached to a variety of different shafts 34.

Data gathered from these ball strikes is generated by a tracking system such as the systems 8 and 9 and the results of strikes using different combinations of clubhead 36 and shaft 34 are analyzed to find an optimum combination of clubhead 36 and shaft 34 for the golfer. In this process, the more precisely the motion and orientation of the clubhead 36 is determined, the more accurately the club fitter can assess the golfer's performance with the various clubheads 36 and shafts 34 to determine the best fit for the golfer. To that end, it will be understood by those skilled in the art, the embodiments described herein that enhance the precision with which the motion and orientation of the clubhead 36 is determined as well as the mechanics of the impact with the golf ball 20 and the resulting trajectories of the struck gold balls 20, will enhance the results of club fittings as well as the efficacy of training sessions based on the swing data produced by the systems 8 and 9.

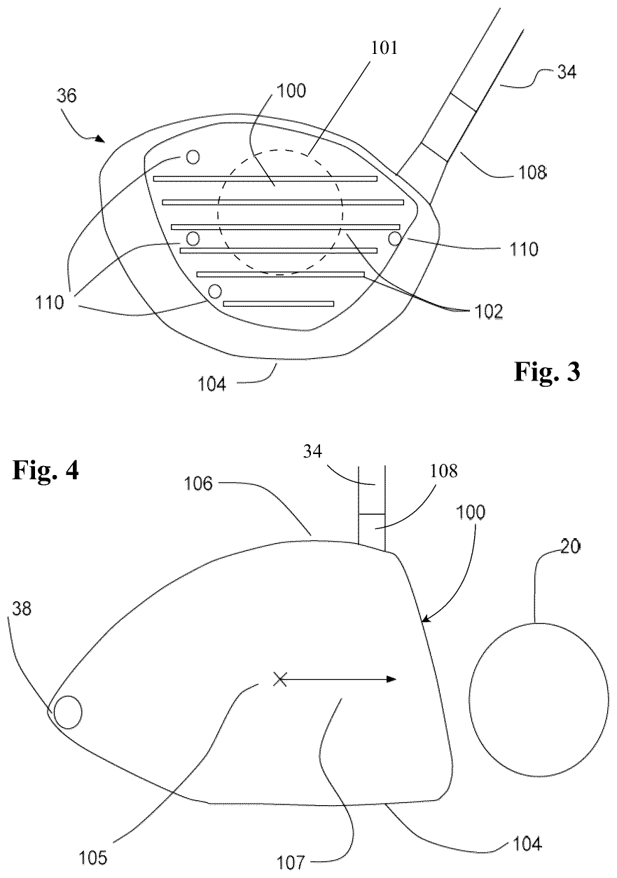

As shown in FIG. 3, the club face 100 is a part of the clubhead 36 configured to strike the golf ball 20 and the orientation, shape and make-up of the club face 100 have a significant effect on the three-dimensional travel parameters (e.g., launch angle, spin rate, and ball speed) of the golf ball 20. The club face 100 of the golf club 30 is designed to maximize ball speed and reduce energy loss upon impact while imparting a desired spin to the golf ball 20. Manufacturers employ various face technologies, such as grooves 102, variable thickness, flex zones or unique patterns or materials to optimize ball launch conditions. The clubhead 36 has a sole 104 which is the part of the clubhead 36 closest to the ground and which affects the interaction of the golf club 30 with the ground (e.g., turf). The clubhead 36 has a Center of Gravity (CoG) 105 moving toward the golf ball 20 along a path marked in FIG. 4 by arrow 107. The crown 106 is the top part of the clubhead and influences the club's aerodynamics and weight distribution. The hosel 108 is the part that connects the clubhead 36 to the shaft 34 and allows for adjustments in loft, lie, and face angle.

According to an embodiment, multiple markers 110 can be formed on or embedded in the club face 100 of the clubhead 36. In the illustrated embodiment, four markers 110 surround an impact area 101 of the club face 100. As would be understood by those skilled in the art, the materials and design of the clubhead 36 are generally selected to offer a balance of strength, weight and flexibility with modern drivers incorporating materials such as titanium, carbon composite or other lightweight materials that facilitate increased speed of the clubhead 36 and which allow for weight redistribution to optimize performance. The placement of the center of gravity (CoG) is crucial for optimizing launch conditions and ball flight and is carefully positioned to achieve a desirable combination of a targeted launch angle, low spin (for drivers) and stability. As changes to even seemingly minor details may significantly affect shot shape, forgiveness, and overall performance, it is important that modifications proposed to enhance tracking have little to know impact on the physical construction of the clubhead 36.

FIG. 5 illustrates the clubhead 36 of a driver shown in FIGS. 2 and 3 but seen from the rear side or the side facing away from the club face 100. The rear side of the clubhead 36 in one embodiment is provided with several optional markers 110. In the illustrated embodiment, three markers are placed so these markers 110 will be visible to a camera positioned behind the area from which the ball is to be launched during the approach of the clubhead 36 to the golf ball 20 and through impact. In this embodiment, one of the markers 110 is arranged close to or coinciding with the radar reflector element 38.

The markers 110 as well as the radar reflector element 38 may be embedded in the clubhead 36 below an outer protective cover layer that is transparent with regard to the radiation from the radar unit 10 and with regard to the portion of the spectrum to which the cameras 71, 72 are sensitive so that the markers 110 are visible to in images made by the cameras 70 and 72 (i.e., the markers 110 stand out from surrounding areas of the clubhead 36 sufficiently to be identified and located through automated image processing as would be understood by those skilled in the art. Similarly, as indicated above, the radar reflector element 38 is formed of a material having a reflectivity with respect to the radiation from the radar unit 10 that is sufficiently different from the reflectivity of the materials forming surrounding portions of the clubhead 36 so that the portion of the reflected radiation corresponding to this radar reflector element 38 will stand out from a remaining portion of the radar signature that the signal processing software can identify this portion of the signal.

Though the markers 110 in FIGS. 3, 4 and 5 are shown as circular markers, those skilled in the art will understand that markers 110 of different sizes and shapes may be used without departing from the scope of the disclosed embodiments. Furthermore, the circular markers 110 are shown with all of the markers 110 having the same diameter (e.g., from 5-8 mm), yet in other embodiments the diameters of the markers 110 may differ from one another in a known pattern so that a location associated with any one of the markers 110 can be identified even in an image where only a single marker 110 is visible.

As indicated above, if desired, any or all of the markers 110 may be formed to reflect near infrared radiation outside the visible spectrum—(NIR) markers. Thus, these markers may be made in a manner that is not visible to the golfer and will not change the appearance of the clubhead 36. As would be understood by those skilled in the art, such markers 110 are configured for use in conjunction with cameras sensitive to near infrared radiation. Furthermore, those skilled in the art will understand that if one of the cameras 70, 72 is sensitive to near infrared radiation and the other camera 70,72 is sensitive to visible light, the markers 110 on the rear of the clubhead 36 will be made reflective of the type of radiation to which the camera 70 is sensitive while the markers 110 on the club face 100 of the clubhead 36 will be made reflective of visible light. Those skilled in the art will also understand that optical bandpass filters and image processing will be tailored to enhance the visibility of the markers 110 to the one of the cameras 70, 72 facing the corresponding side of the clubhead 36.

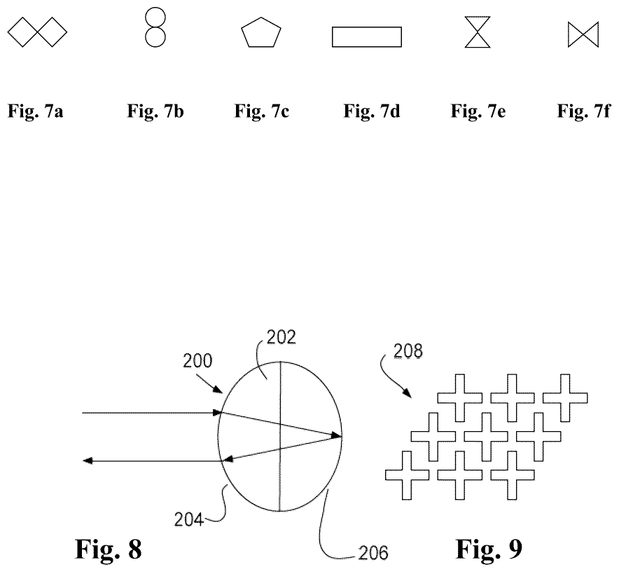

FIGS. 7a-7f show various shapes of markers 110 that may be used in any combination, in combination with circular markers 110, etc. The markers may also be designed to facilitate the precise identification by the system 8, 9 of a particular point associated with each marker (e.g., a point of intersection between adjacent diamonds, the center of a circle or other geometric shape). This may enable the system to more accurately locate the club head in three dimensions throughout the swing. For example, FIG. 7a shows a marker 110 formed from two squares joined to each other corner to corner. The joined squares may also be rotated, e.g., 45 degrees or 90 degrees relative to one another in any desired orientation (e.g., one square may be rotated so that the two squares meet where one corner of one square meets a side of the other square at a single point). The squares may also be oriented in a known manner relative to the horizontal (e.g., when the club is in a desired ball striking orientation).

This ensures that not only the overall pattern (comprising four markers) on the club face 100 will include orientation information, but also that each individual marker 110 will furnish such orientation information further enhancing the position determination for the clubhead 36. FIG. 7b shows a marker 110 including two circles touching one another at a single point. As would be understood by those skilled in the art, the circles of this marker 110 may be arranged in a vertical or horizontal pattern (or in any other known relation to the vertical) so that this marker 110 may also provide directional information even if only a single marker 110 is visible in a given image. FIGS. 7c and 7d show further alternative shapes including orientation information, namely a pentagon (polygon) and a rectangle, respectively. As these markers 110 are not symmetric with respect to both horizontal and vertical axes, a single such marker 110 can also provide directional information regarding the orientation of the clubhead 36. Those skilled in the art will understand that a single clubhead 36 may include any number or markers 110 of various shapes in any combination of shapes and orientations of these shapes desired to enhance tracking of the clubhead 36.

As indicated above, the purpose of integrating the radar reflector element 38 into the clubhead 36 is to ensure that each radar reflector element 38 will appear as a well-defined hotspot or peak in the Doppler signal. The radar reflector element 38 is configured to create in the Doppler signal a small well-defined point with high intensity as compared to remaining parts of the clubhead 36 which will generally appear blurred due to their lower radar reflectivity. This enables the processor 62 to accurately track the point shaped radar reflector elements 38 during the downswing through impact and during the follow-through after impact with the golf ball 20.

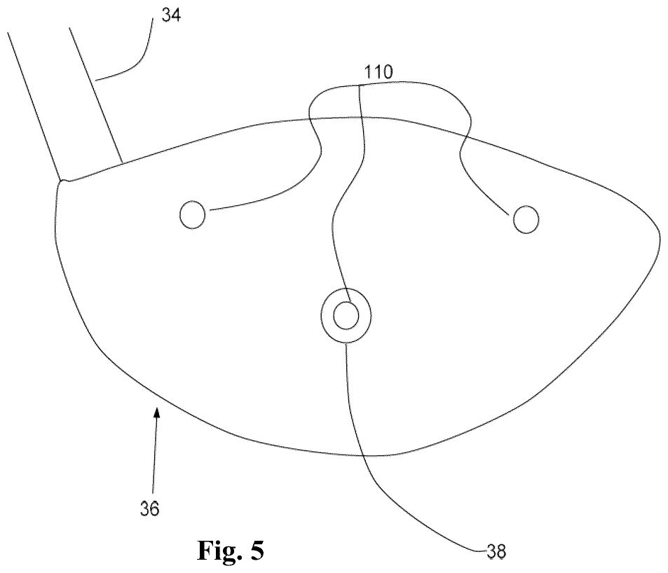

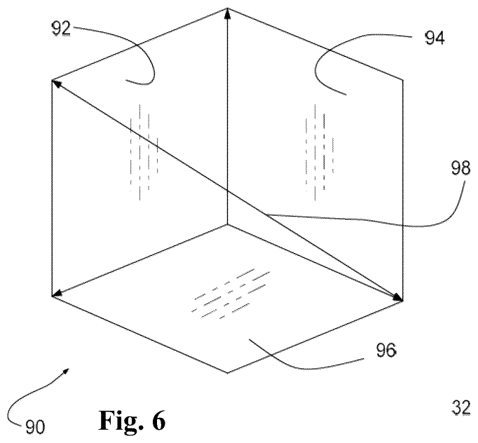

The radar reflector element 38 according to one embodiment is formed as a retroreflector that reflects radiation back to its source with minimal scattering. Unlike a planar mirror, the retroreflector works to reflect to the radar unit 10 radiation through a wide range of angles of incidence. According to one embodiment of the present disclosure, the radar reflector element 38 comprises a corner reflector 90 as shown in FIG. 6. The corner reflector 90 has three orthogonal sides 92, 94, and 96, positioned to face outward from the clubhead to reflect the transmitted radiation 16 from the radar unit 10 back toward its origin—i.e., the radar unit 10.

The orthogonal sides 92, 94, and 96 of the corner reflector 90 in one embodiment are formed, for example, of metallic materials having good electrically conductive properties, e.g., silver, copper, gold, or aluminum. The corner reflector 90 may be embedded into a body of a plastic or another appropriate material (e.g., material transparent or semi-transparent to the transmitted radiation 16 from the radar unit 10) before being positioned in the clubhead 36 during manufacturing. Alternatively, the corner reflector 90 can be mounted in the clubhead 36 with the reflective surface exposed as the shape of the back of the clubhead 36 is generally unimportant to the extent that the distribution of weight on the clubhead 36 is unaffected. The corner reflector 90 might have curved edges to blend in with the design of the clubhead 36 while still maintaining a corner reflector function as would be understood by those skilled in the art.

As would be understood by those skilled in the art, the incorporation of the corner reflector 90 into the clubhead 36 must meet certain volume restraints. For the K-band, the wavelength is approx. 1.25 cm. However, in the present embodiment, it is desired to maintain a major dimension 98 less than 4 mm. Even when meeting these volumetric constraints, the corner reflector 90 enhances the reflected radiation 18 in a manner ensuring that the echo from the corner reflector 90 is 2-3 dB stronger than the echo from the rest of the clubhead 36.

FIGS. 8 and 9 illustrate an alternative embodiment of the radar reflector element 38 for use in accord with the disclosed embodiments. A reflector element 200 is provided as a frequency selective spherical silica ball lens 202 with a reflective cap 206 (e.g., an aluminized hemispherical cap) and an aperture 204 covered by a frequency-selective surface pattern 208. The frequency-selective surface pattern 208 of this embodiment may be formed as a thin layer with a repetitive pattern configured to permit electromagnetic energy of the frequency provided by the radar unit 10 to pass through it into the lens 202 so that the energy is focused on the reflective cap 206 and reflected back toward the radar unit 10. The repetitive pattern 208 of the frequency-selective surface covering the aperture 204 of one embodiment is a crossed-dipole aperture made from an electroplated Nickel layer covering the aperture 204 of the reflector element 200. As would be understood by those skilled in the arts, the reflector element 200 may be formed as a terahertz retroreflector as described, for example: “In Frequency Selective Terahertz Retroreflectors” by Richard James Williams, 2014, tailored to selectively pass frequencies generated by the radar unit 10.

The clubhead 36 moves through impact on the arc segment 40, while simultaneously rotating about an axis separate from the radius of the arc segment 40. Thus, different parts of the clubhead 36 travel at different speeds and in different directions.

The markers 110 and/or the radar reflector element(s) 38 can be placed on the clubhead 36 in a pattern that will identify the clubhead 36 (e.g., type of club, manufacturer and make) and may even identify a type of shaft 34 of the golf club 30. As would be understood by those skilled in the art, the systems 8, 9 may analyze images and/or radar data to identify the golf club 30 automatically. This may also permit the compilation of a database of golf shots that can be automatically sorted by club type or club and shaft combinations to determine the performance of a single user using different equipment and/or the performance of multiple users sorted by the equipment used. As would be understood by those skilled in the art, this data may be combined and used in analysis in conjunction with a host of other types of data relevant to player performance (e.g., shot distance, accuracy, spin rates and spin axes achieved, impact on handicaps, etc.) and to the performance of groups and/or types of players as well as to the performance of equipment such as differing types of clubheads 36, shafts 34, etc.

Alternatively, or in addition, a barcode may be placed on the clubhead 36 encoding this information. If desired, this barcode may be placed on the clubhead 36 in a manner visible only to near infra-red imaging and thus not changing the appearance of the clubhead 36. In addition, as would be understood by those skilled in the art, the systems described herein may learn the appearance of individual clubs through the identification of any types of markings unique to a given golf club 30 including scratches, stains, etc. so that the golf clubs 30 can be identified by type and even user. For example, a pattern of scratches on a 5 iron can be identified by a matching of current images to stored images so that the system will know not only that this is a 5 iron (including information concerning loft angle, etc.) but may also know that this is a 5 iron associated with a specific user.

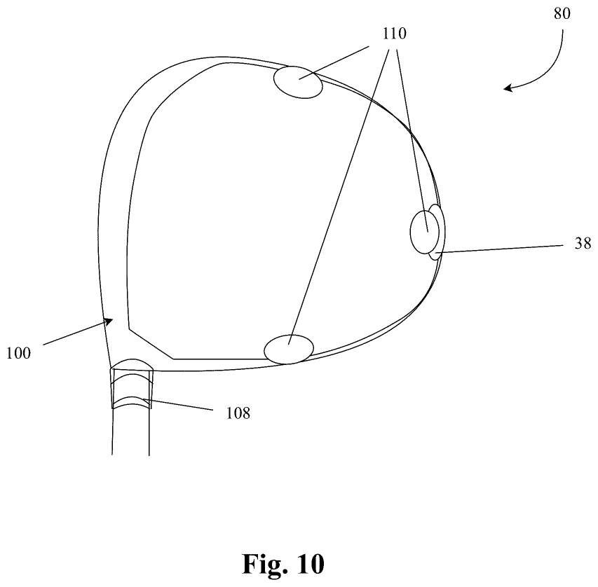

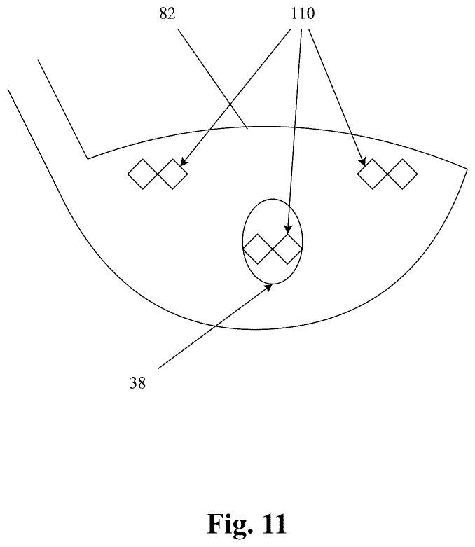

FIG. 10 shows a clubhead 80 according to a further embodiment including markers 110 (e.g., near infrared markers) on opposite sides of the back of the clubhead 80 as well as a marker 110 in the center of the back of the clubhead 36. In addition, the clubhead 80 also includes a radar reflector element 38 in the center of the back of the clubhead 80. In this embodiment, as the marker 110 overlays the radar reflector element 38, the marker 110 is formed of a material that is at least semi-transparent to the radiation transmitted by the radar unit 10. Similarly, FIG. 11 shows a back of a clubhead 82 according to a further embodiment in which the markers 110 are shaped as side-by-side diamonds as shown in FIG. 7a. In the clubhead 82, the markers 110 are also placed on the rear of the clubhead 82 with a first marker 110 on the side of the clubhead 82 adjacent to the hosel 108 and a second one of the markers 110 adjacent to a toe. The clubhead 82 also includes a marker 110 and a radar reflector element 38 in the center of the rear of the clubhead 82. As can be seen in FIG. 11, the radar reflector element 38 of this embodiment is substantially circular with a diameter of approximately 4 mm.

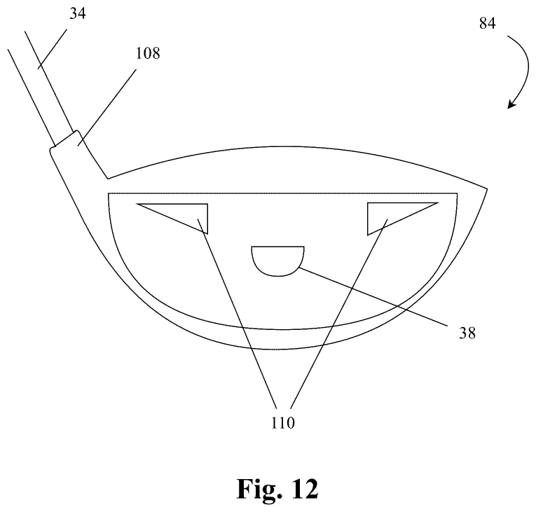

Finally, the clubhead 84 of FIG. 12 includes two markers 110 on opposite sides of the rear of the clubhead 84 (e.g., one adjacent to the toe of the club and one adjacent to the hosel) with each of the markers 110 formed as a triangle. The clubhead 84 also includes a radar reflector element 38 formed as a hemisphere of 4 mm radius formed at a center of the rear of the clubhead 84. Those skilled in the art will recognize that the shapes and locations of the various markers 110 and the radar reflector elements 38 may be varied and combined in any desired manner to enhance tracking of the clubhead or, for example, to create a unique pattern to identify the club, club head and/or the shaft.

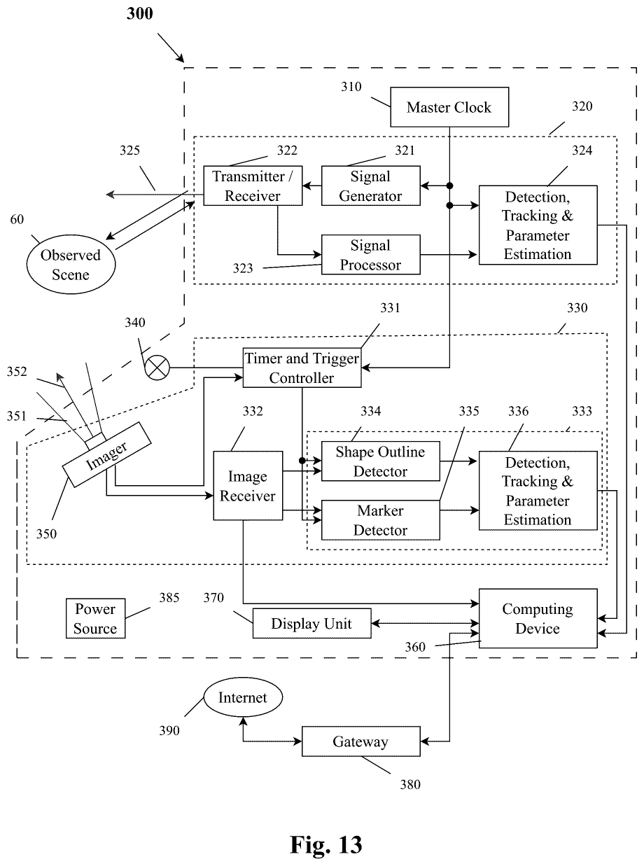

FIG. 13 illustrates one embodiment of a system for tracking a motion of a golf club. The system comprises a tracking device 300 configured to track motion of a golf club and to generate tracking data corresponding to a position of the golf club during a swing of the golf club. The illustrated tracking device 300 comprises an exemplary radar sensor 320 and an imaging sensor 330 (although either of these may be omitted, substituted for another type of tracking device (e.g., lidar) or supplemented by any number of additional tracking devices) as would be understood by those skilled in the art. Furthermore, the tracking device 300 comprises a master clock unit 310 ensuring synchronization between the radar sensor 320 and the imaging sensor 330 and/or any other sensing devices that may be included in the system.

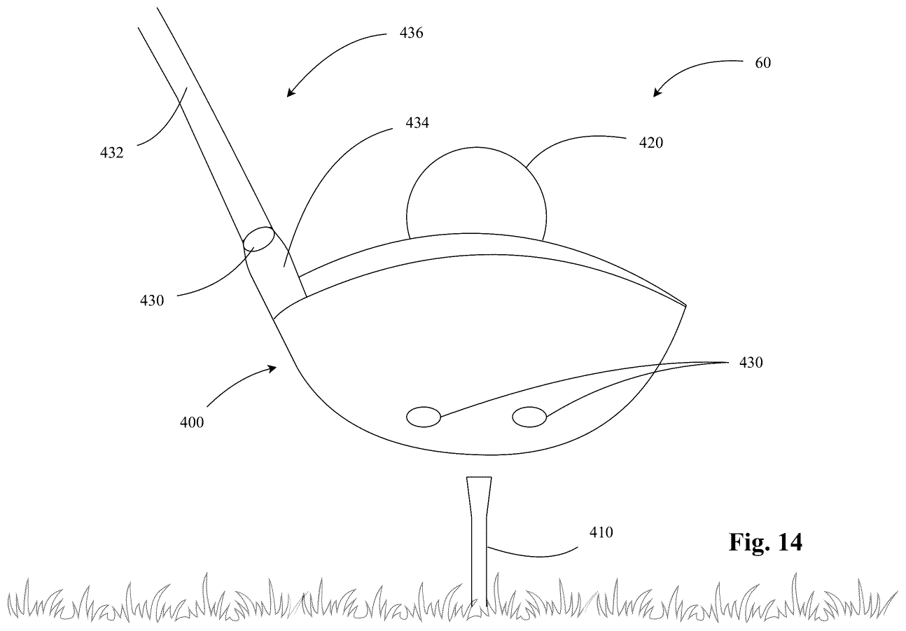

FIG. 14 shows an example/image of an observed scene 60 captured by the imaging sensor 330 of the tracking device 300 according to one embodiment of the invention. As seen in FIG. 14, the swinging club 436 has just lifted a golf ball 420 from a tee 410 due to impact between the clubhead 400 and the golf ball 420. It is furthermore seen from the image, that the clubhead 400 includes three markers 430. In the illustrated embodiment, two of these markers 430 are provided on a lower part of the back of the clubhead 400, while the third marker 430 is provided on a hosel 434 connecting the clubhead 400 to a club shaft 432. When the tracking device 300 is placed behind the golfer swinging the golf club 436, the three markers 430 will be visible to the tracking device 300 during downswing of the golf club 436 towards impact with the golf ball 420.

A master clock unit 310 provides a common time reference for the radar sensor 320 and the imaging sensor 330 so that data from the radar sensor 320 and the imaging sensor 330 can be time synchronized to ensure accuracy of the tracking information based on a combination of data from these two sources (as well as any other sources of data). This time synchronization ensures that each radar data point and every imager data point have a common time base. The time synchronization can be achieved in many ways. According to one exemplary method a hardware trigger signal is inserted into and recorded in the radar data when each image is taken. Furthermore, the imaging sensor 330 may provide to the radar sensor 320 (or to any connected data processing device) a signal indicating a timing of the capture for each image (each frame) so that a computing device 360 may determine a time correspondence between each of the images and the corresponding radar data. In one embodiment wherein the radar sensor 320 is a doppler radar, the doppler signal is sampled with a sampling rate of 40 kHz.

This allows the computing device 360 to combine radar data and imager data in a technology referred to as Optically Enhanced Radar Tracking (OERT). OERT allows the computing device 360 to provide state-of-the-art accuracy in tracking club movement and ball flight. OERT accurately captures a location on the clubface of impact with the golf ball 420. Data from the radar sensor 320 may be used for optimal speed and distance measurement, while the imaging sensor 330 provides superior angular data and directly measured 3D spin although those skilled in the art will understand that this is exemplary only.

The radar sensor 320 may, for example, be a continuous wave Doppler radar emitting microwaves at X-band (approx. 10 GHz) or at K-band (approx. 24 GHz). Any type of continuous wave (CW) Doppler radar may be used, including phase or frequency modulated CW radar, multi frequency CW radar or a single frequency CW radar although pulse radar may also be used in certain applications. The exemplary radar sensor 320 has a signal generator 321 providing a radar signal at a predetermined carrier frequency and having a predetermined phase or frequency modulation. This radar signal is emitted by a transmitter part of the transceiver 322 towards the observed scene 60 so that a part of the emitted radar signal reflected by various elements in the observed scene 60 will be picked up by the receiver part of the transceiver 322 as would be understood by those skilled in the art.

A distance from the tracking device 300 to any or all of the moving objects in the observed scene 60 may be determined based on a delay between the transmitted and a portion of the received radar signal corresponding to the various moving objects. The transmitter and receiver elements of a tracking radar are preferably be placed in a transmitter/receiver plane (e.g., mounted on a planar substrate) having a normal vector 325. In this exemplary embodiment the receiver includes, e.g., a plurality of receivers arranged to form at least two pairs of receivers (e.g., on the substrate within the transmitter/receiver plane) with each of the pairs orthogonal to one another on the substrate, a direction-of-arrival for (offset angle relative to the normal vector 325) the received radar signal may be determined by analyzing the phase difference between the receivers in the pair of receivers as would be understood by those skilled in the art. Furthermore, as would be understood by those skilled in the art, the two pairs of receivers may be formed by only three receivers arranged in an L shape with one of the receivers being common to both of the orthogonally related pairs.

By analyzing the radar signal received at the transceiver 322 (e.g., noting differences in frequency and phase between the transmitted and received signals and noting phase difference between different portions of the received signal), a radial velocity of moving objects in the observed scene 60 relative to the radar sensor 320 and data concerning a distance to the moving objects in the observed scene 60 is obtained. In a signal processor 323, the received Doppler radar signals are digitized and transformed into the frequency domain, e.g. by applying an appropriate short-time Fourier transform (STFT) algorithm, and the output from the signal processor 323 may be visualized as a so-called spectrogram illustrating the frequency of the Doppler signal over time or output in any other desirable form. The output from the signal processor 323 is fed to a processor 324 for detection, tracking and parameter estimation, based on spectral content present in the spectrogram, and the evolution over time of the spectral content. When monitoring a golf shot, the radar sensor 320 may determine range (position), velocity and rotation (spin) of objects (including ball and club head) during the downswing and shortly after impact. In short, the radar sensor 320 is configured to three-dimensionally track objects within the observed scene 60. The data from the radar sensor 320 may also be transferred to a computing device 360 for further processing.

In some embodiments, the tracking device 300 has at least two radar sensors 320 where a first one of the radar sensors 320 is a so-called X-band radar and a second one of the radar sensors 320 is a so-called K-band radar. As would be understood by those skilled in the art, the X-band radar will generally have a smaller antenna allowing for more precise target resolution and a Higher Target Sensitivity enabling it to detect smaller objects due to its higher sensitivity and higher-resolution imaging. The shorter wavelength of the X-band radar thus enables the system to more effectively identify targets at longer distances. The K-band radar operates at a higher frequency and with lower power output and, thus, is less effective than the X-band radar at detecting objects at longer distances. However, the K-band radar has better resolution and better target identification for objects close to the radar sensor as compared to an X-band radar. Thus, a system having two radar sensors 320 arranged as described above (e.g., including transmitter and receiver elements arranged in the same plane, e.g., on the same substrate in a predefined positions relative to one another), enables a tracking device 300 forming a Dual Radar system, with the two radar sensors synchronized to one another in time and space. As would be understood by those skilled in the art, one of these radar sensors may be a short range, ultra high-resolution system (e.g., a K-band radar) focused on putting, detecting club and impact data while the other may be a long range, high accuracy radar sensor 320 (e.g., an X-band radar) configured to track the flight and/or full paths of travel of longer range shots (e.g., drives, iron shots, etc.).

The imaging sensor 330 of an exemplary embodiment includes at least one Imager 350. The Imager 350 includes, in the illustrated embodiment, an image sensor with a low-power mode for capturing images at a lower frame rate (e.g., between 25 and 60 fps (frames per second)), and a high-power mode for capturing images at a higher frame rate (e.g., between 250 and 4000 fps or higher). Those skilled in the art will understand that currently high-speed imagers are available that operate at 4000 fps or higher. However, as such imagers improve and/or come down in cost higher frame rates and/or resolutions may be incorporated into any of the systems disclosed in this application. For example, the Imager 350 of one exemplary embodiment may be a 1.3 Megapixel camera with a Global Shutter CMOS Digital Sensor supporting multiple simultaneous Region-Of-Interest readouts with flexible window positions. This allows the imaging sensor 330 to reduce the resolution of the imager 350 when operating in the high-power mode if desired to reduce required processing power and the storage capacity necessary to hold a desired number of image frames.

The imager 350 has a viewing direction 351 and a field of view 352 configured to see, in an exemplary embodiment, the entire observed scene 60. However, those skilled in the art will understand that alternative embodiments may include multiple imagers having fields of view (exclusive and/or overlapping) that combine to cover all or a desired portion of the observed scene 60. The tracking device 300 may, for example, be placed 3-4 meters behind the player that will strike the golf ball, or any distance selected to avoid interference with the player's swing and to ensure proper collection of data regarding the swing, impact and launch characteristics associated with a golf shot. The distance between the imager 350 and the radar sensor 320 is generally small as compared to this distance to a farther portion of the observed scene 60 with the radar sensor 320 and the imager 350 being arranged, for example, so that the normal vector 325 and the viewing direction 351 are substantially parallel (i.e., when a distance between the imager 350 and the radar sensor 320 is small compared to the length of a tracked golf shot, the normal vector 325 and the viewing direction 351 will be substantially parallel with respect to positions of the ball as it travels to its final resting position.

The imaging sensor 330 of this embodiment has a timer and trigger controller 331 receiving input from the master clock unit 310 and a triggering device (not shown). The timer and trigger controller 331 may, in an exemplary embodiment, control when the Imager 350 operates in the low power mode and when the imager 350 operates in the high-power mode. The timer and trigger controller 331 is also responsible for setting the actual frame rate in the low power mode and in the high-power mode. In the illustrated embodiment, the timer and trigger controller 331 is also responsible for activating (switching on) an optional light source 340 allowing the imager 350 to capture clear images in low-light conditions. This is particularly useful when the tracking device 300 is used outside during twilight. The timer and trigger controller 331 is also responsible for time stamping image frames in order to ensure a high degree of synchronization between radar and imager data when processed and combined for parameter determination. Frames or parts of frames are read out from the imager 350 and fed into an image received 332. The image receiver 332 encodes the raw image data (and audio if available) from the imager into, for example, a video stream that is forwarded to the computing device 360. The image receiver 332 furthermore delivers successive images or parts thereof from the imager 350 to a processor 333 for detection, tracking and parameter estimation, of objects present in the images, and movement of the objects over time.

A shape outline detector 334 is a routine or a program running on the processor 333 in an exemplary embodiment that detects an outline of an object in one or more images of a sequence of images. The shape outline detector 334 may include, for example, OpenCV, which is a popular open-source computer vision library that provides tools for contour detection. Initially the image (or a selected portion thereof) is converted to grayscale and a Gaussian blur is applied to reduce noise. Then an edge detector (e.g., a Canny edge detector) is used to identify edges of one or more objects in one or more images of the series of images. These detected edges are then matched (for example, in a detection, tracking and parameter estimation component 336 of the processor 333) to the objects expected to be found in in the observed scene 60 to identify, for example, portions of the images corresponding to a golf ball and/or a golf club.

In parallel to shape outline detector 334 receiving successive images or parts thereof from the imager 350, a marker detector component 335 is configured to detect, in successive images or parts thereof received from the imager 350, the presence of markers 430 on the golf club 436 and their position in the 2D image plane. This may be done via, e.g., simple color or brightness detection as the markers 430 due to their reflective characteristics will generally appear brighter than their surroundings. The detected position of the markers 430 in an image may increase the precision of the position determined for the clubhead 400 for the point of time at which the image was captured and, when a 3D contour of the clubhead 400 including the positions of the markers 430 thereon is known, the detected positions of the markers 430 may be used to determine the 3D orientation of the clubhead 400. This determination may then be repeated for successive images, and outputted to the detection, tracking and parameter estimation component 336 of the processor 333 to track the observed objects.

When the tracking device 300 is placed behind the player, the computing device 360 may provide accurate data for both the golf club 436 and the golf ball 420 for any shot. Of course, those skilled in the art will understand that other locations of the tracking device 300 may be selected. The computing device 360 may apply OERT based on the received radar and imager data as disclosed, for example, in U.S. Pat. No. 10,989,791 B2 by synchronizing a camera with the radar to capture a more precise position of the golf ball 420 and clubhead 400 up to an including the time of impact as well as the time following impact. In this case, the position of the clubhead 400 is measured using a combination of radar and camera data to determine an accurate position of the clubhead 400 at the time corresponding to every frame—and for times in-between frames.

The tracking device 300 according to one exemplary embodiment includes a display unit 370 presenting to a user data determined by the computing device 360 where this data may include, for example, bare data for the golf ball 420 and the impacting golf club 436, an illustrative video sequence captured by the imager 350, or tips for improving the swing technique of the golfer, etc. The display unit 370 may include, for example, a touchscreen permitting the golfer to interact with the tracking device 300 and any other known input and output devices and interfaces.

As would be understood by those skilled in the art, the golfer may supply input to or otherwise control the computing device 360 through simple or multi-touch gestures by touching the screen with a special stylus or one or more fingers. The golfer may control how data is displayed, for example, zooming to increase the text size or image/video details.

The light source 340 may emit light (e.g., infrared (IR) or colored light such as green light) tailored to spectral reception characteristics of the imager 350 and any filters applied to the imager 350. Artificial light may be supplied from the light source 340 to the observed scene 60 to facilitate capture by the imager 350 of details of the object even when the imager 350 is operating in the high-speed mode and/or when the observed scene 60 is underlit.

The artificial light from the light source 340 may also be tailored to reduce glare from bright lights to facilitate the capture of clear images in challenging lighting conditions while IR light may be supplied to reveal details not visible in regular light, such as textures and patterns on surfaces or markers 430 that are not visible to human observers. The artificial light assists the imager 350 to capture details and markers 430 on moving objects configured to reflect the frequencies of radiation emitted by the light source 340. Thus, the markers 430 in FIG. 14 may be more readily distinguished from portions of the golf club 436 not carrying the markers 430.

As would be understood by those skilled in the art, the gateway unit 380 is a network node connecting networks (e.g., having different transmission protocols) and serving as an entry and exit point for the tracking device 300. In one exemplary embodiment all data passes through this gateway unit 380 when uploading to a cloud-based server via the Internet 390.

In the illustrated embodiment, the tracking device 300 may be operated as a portable stand-alone device powered by a power source 385 such as a rechargeable battery. Data is captured by the radar sensor 320 and the imaging sensor 330 and the processor 333 analyzes the tracking data to identify portions of the tracking data corresponding to, for example, a visible or infrared marker 430 on the golf club 436. The marker 430 may be configured to reflect a target type of radiation in a manner distinguishable from the reflection of radiation from portions of the golf club 436 excluding the marker 430 as described above to determine a three-dimensional trajectory of the golf club 436.

The data from the processor 333 and the processor 324 is handed over to the computing device 360 which combines the data from radar sensor 320 and the imaging sensor 330 as described above and presents selected data to the user (e.g., via the display unit 370). The computing device 360 may include a communication element allowing communication to remote devices via a network such as the Internet 390 and a gateway unit 380, e.g., to store data in cloud-based storage. The golfer may then almost instantly retrieve data characterizing his golf strike (e.g., on a personal communication device such as a smartphone). As would be understood by those skilled in the art, the gateway unit 380 may be a wired or wireless Local Area Network (LAN) of a golf course or a Starlink® radio, etc.

The tracking device 300 of one embodiment includes a housing containing all of its constituent components discussed above. The housing includes one or more windows covering the imager 350, the light source 340 and the radar sensor 320, to permit radiation destined for or emanating from these components to travel as necessary for the operation of these elements. Alternatively, any of these components may be included in a number of separate housings as would be understood by those skilled in the art.

The above explained embodiments describe the present disclosure for enhancing the measurement accuracy by launch monitors of a driver golf club. Obviously, the same approach can be used to enhance any other golf club types such as woods, hybrids, irons, wedges, and putters. Also, other types of ball striking implements where devices are used to track the movement of sports items such as balls, pucks, shuttlecocks, etc. and items used to strike these items will see similar benefits in enhanced measurement accuracy. Such systems will find use in the tracking of a variety of items associated with sports such as shoes for soccer and/or American football, baseball bats, cricket bats, tennis rackets, squash rackets, badminton rackets, ice hockey sticks, pucks, balls, etc.

1. A system for tracking a motion of a golf club, comprising:
a tracking device configured to track motion of a golf club and generate tracking data corresponding to a position of the golf club during a swing of the golf club; and
a processor analyzing the tracking data to identify a portion of the tracking data corresponding to a first marker positioned on the golf club, the first marker being configured to reflect a target type of radiation in a manner distinguishable from the reflection of radiation from portions of the golf club excluding the first marker, the processor being configured to determine, based on the tracking data corresponding to the portions of the golf club excluding the first marker and the tracking data corresponding to the first marker, a three-dimensional trajectory of the golf club.

2. The system of claim 1, wherein the tracking data includes data corresponding to at least one of Face Angle, Dynamic Loft, club speed, attack angle, and club path.

3. The system of claim 1, wherein the tracking device includes a first camera and the tracking data comprises a series of images generated by the first camera during the swing of the golf club, the processor being configured to identify the first marker in the images and to analyze positions of the first marker in the images to determine a three-dimensional position and orientation of the golf club at times corresponding to each of the images of the series of images.

4. The system of claim 3, wherein the tracking device includes a radar unit and wherein the tracking data comprises radar data corresponding to one of a range and a range rate of a target portion of the golf club relative to the radar unit.

5. The system of claim 4, wherein the target portion of the golf club includes a head of the golf club and wherein the first marker is located on the head of the golf club.

6. (canceled)

7. The system of claim 1, wherein, when the golf club includes a second marker positioned on a head of the golf club, the processor is configured to determine based on a portion of the tracking data corresponding to movement of the first and second markers, a three-dimensional path of movement of the head of the golf club during the swing.

8. The system of claim 7, wherein the processor is configured to determine, based on the portion of the tracking data corresponding to the movement of the first and second markers, a three-dimensional orientation of the head of the golf club during the swing.

9. The system of claim 3, wherein the first camera faces a target area within which the golf club is to be swung, the first camera being positioned to capture images of a face of a head of the golf club when the golf club is swung in the target area in a target direction.

10. The system of claim 9, further comprising:
a second camera facing the target area, the second camera being positioned to capture images of a rear surface of the head of the golf club when the golf club is swung in the target area in the target direction.

11-14. (canceled)

15. The system of claim 3, wherein the first camera is positioned above a target area within which the golf club is to be swung, the first camera being positioned above to capture images of a top of a head of the golf club when the golf club is swung in the target area in a target direction.

16. The system of claim 4, wherein the radar unit is a three-dimensional doppler radar and wherein the tracking data includes three-dimensional positioning data for a head of the golf club during at least a portion of a golf swing before and through a time of impact with a golf ball.

17. The system of claim 16, wherein the tracking data includes an orientation of the head of the golf club during the portion of the golf swing.

18. The system of claim 3, wherein the first camera is sensitive to light in a near infra-red portion of a spectrum and wherein, when the first marker is distinguishable from a material of the golf club surrounding the first marker in the near infra-red spectrum and is not distinguishable from the material of the golf club surrounding the first marker in a visible portion of the spectrum.

19. A method for tracking a motion of a golf club, comprising:
generating tracking data via a tracking device configured to track motion of a golf club, the tracking data corresponding to a position of the golf club during a swing of the golf club; and
analyzing, using a processor, the tracking data to identify a portion of the tracking data corresponding to a first marker positioned on the golf club, the first marker being configured to reflect a target type of radiation in a manner distinguishable from the reflection of radiation from portions of the golf club excluding the first marker, the processor being configured to determine, based on the tracking data corresponding to the portions of the golf club excluding the first marker and the tracking data corresponding to the first marker, a three-dimensional trajectory of the golf club.

20. The method of claim 19, wherein the tracking data includes data corresponding to at least one of Face Angle, Dynamic Loft, club speed, attack angle, and club path.

21. The method of claim 19, wherein the tracking device includes a first camera and the method further comprising:
generating, via the first camera, a series of images during the swing of the golf club, and identifying via the processor the first marker in the images and analyzing, using the processor, positions of the first marker in the images to determine a three-dimensional position and orientation of the golf club at times corresponding to each of the images of the series of images.

22. The method of claim 21, wherein the tracking device includes a radar unit and the method further comprising:
generating, via the radar unit, radar data corresponding to one of a range and a range rate of a target portion of the golf club relative to the radar unit.

23. (canceled)

24. The method of claim 19, wherein, when the golf club includes a second marker positioned on a head of the golf club, determining by the processor based on a portion of the tracking data corresponding to movement of the first and second markers, a three-dimensional path of movement of the head of the golf club during the swing.

25. The method of claim 24, further comprising:
determining by the processor, based on the portion of the tracking data corresponding to the movement of the first and second markers, a three-dimensional orientation of the head of the golf club during the swing.

26. The method of claim 21, further comprising:
capturing, using the first camera, images of a face of a head of the golf club during the swing of the golf club.

27. The method of claim 26, further comprising:
capturing via a second camera images of a rear surface of the head of the golf club during the swing of the golf club.

28-49. (canceled)
